(19) United States
(12) Patent Application Publication
(10) Pub. No.: US 2026/0287337 A1
(43) Pub. Date: Sep. 24, 2026

(54) LASER DETECTION OF WAFER TYPE AND ORIENTATION

(71) Applicant: Axcelis Technologies, Inc., Beverly, MA (US)

(72) Inventor: FHM Faridur Rahman, Boxford, MA (US)

(21) Appl. No.: 19/088,976

(22) Filed: Mar. 24, 2025

(51) Int. Cl. G01B 11/27

(52) U.S. Cl. CPC G01B 11/272

(57) ABSTRACT

A system includes a stage that is configured to hold a workpiece in a chamber. A light source is configured to direct an incident beam at a surface of the workpiece on the stage. The incident beam is directed at the surface of the workpiece at an incident angle, θ, with respect to a normal axis to the surface. A detector is configured to measure intensity of the incident beam reflected off the workpiece. A processor is configured to determine an orientation of the workpiece relative to the stage using measurements of the intensity.

### FIELD OF THE DISCLOSURE

This disclosure relates to process control during workpiece processing.

### BACKGROUND OF THE DISCLOSURE

In the manufacture of semiconductor devices, ion implantation is used to dope semiconductors with impurities. Ion implantation systems are often used to implant a workpiece, such as a semiconductor wafer, with ions from an ion beam to produce n-type or p-type material doping or to form passivation layers during fabrication of an integrated circuit. Such beam treatment can selectively implant the workpieces with impurities of a specified dopant material, at a predetermined energy level, and in controlled concentration to produce a semiconductor material during fabrication of an integrated circuit. When used for doping semiconductor wafers, the ion implantation system injects a selected ion species into the workpiece to produce the desired extrinsic material. Implanting ions generated from source materials such as antimony, arsenic, or phosphorus, for example, results in an “n-type” extrinsic material workpiece, whereas a “p-type” extrinsic material workpiece often results from ions generated with source materials such as boron, gallium, or indium.

A typical ion implanter includes an ion source, an ion extraction device, a mass analysis device, a beam transport device, and a process chamber. The ion source generates ions of desired atomic or molecular dopant species. These ions are extracted from the source by an extraction system, typically a set of electrodes, which energize and direct the flow of ions from the source, forming an ion beam. Desired ions are separated from the ion beam in a mass analysis device, typically a magnetic dipole performing mass dispersion or separation of the extracted ion beam. The beam transport device, typically a vacuum system containing a series of focusing devices, transports the ion beam to the workpiece processing device while maintaining desired properties of the ion beam. Finally, workpieces are transferred into and out of the process chamber via a workpiece handling system, which may include one or more robotic arms, for placing a workpiece to be treated in front of the ion beam and removing treated workpieces from the ion implanter.

### BRIEF SUMMARY OF THE DISCLOSURE

A system is provided in a first embodiment. The system includes a chamber; a stage configured to hold a workpiece; a light source configured to direct an incident beam at a surface of the workpiece on the stage; a detector configured to measure intensity of the incident beam reflected off the workpiece; and a processor in electronic communication with the detector. The stage is disposed within the chamber. The incident beam is directed at the surface of the workpiece at an incident angle, θ, with respect to a normal axis to the surface. The processor is configured to determine an orientation of the workpiece relative to the stage using measurements of the intensity. The light source may be a laser and the incident beam may be predominantly red light. In an instance, the incident beam has a diameter from 0.5 mm to 0.7 mm. θ may be from >0° and <90°.

The detector may be a camera. The stage may be an electrostatic chuck. The workpiece may be a silicon-on-glass wafer.

The system may include a second light source and a second detector. The second light source and the second detector are configured to measure intensity of a second incident beam reflected off an opposite surface of the workpiece.

The processor may be configured to determine a type of material on the surface of the workpiece that reflects the incident beam.

A method is provided in a second embodiment. The method includes directing an incident beam from a light source at a workpiece on a stage in a chamber. The incident beam is directed at a surface of the workpiece at an incident angle, θ, with respect to a normal axis to the surface. The incident beam is reflected off the surface of the workpiece. Intensity of the incident beam that is reflected off the workpiece is measured. Using a processor, an orientation of the workpiece relative to the stage is determined using measurements of the intensity. The light source may be a laser and the incident beam may be predominantly red light. θ may be from >0° and <90°. The workpiece may be a silicon-on-glass wafer.

The method may include measuring intensity of a second incident beam that is reflected off an opposite surface of the workpiece. In an instance, the method includes comparing the measurements of the intensity of the incident beam and the measurements of the intensity of the second incident beam when determining the orientation.

The method can include determining a type of material on the surface of the workpiece that reflects the incident beam.

A non-transitory computer-readable storage medium is provided in a third embodiment. The non-transitory computer-readable storage medium includes one or more programs for executing the following steps on one or more computing devices. Measurements of intensity of an incident beam of light reflected off a surface of a workpiece on a stage are received. The incident beam is directed at a surface of the workpiece at an incident angle, θ, with respect to a normal axis to the surface. An orientation of the workpiece relative to the stage is determined using measurements of the intensity. The workpiece may be a silicon-on-glass wafer.

The determining may use measurements of an intensity of a second incident beam of light of an opposite surface of the workpiece.

The steps may include determining a type of material on the surface of the workpiece that reflects the incident beam.

### DESCRIPTION OF THE DRAWINGS

For a fuller understanding of the nature and objects of the disclosure, reference should be made to the following detailed description taken in conjunction with the accompanying drawings, in which:

FIG. 1 is a diagram of an exemplary system for determining orientation of a workpiece in accordance with the present disclosure;

FIG. 2 illustrates exemplary reflectance and transmission for different materials and angles;

FIG. 3A is a diagram that shows various light paths that are possible when different interfaces are present;

FIG. 3B illustrates an exemplary speckle pattern obtained using the techniques disclosed herein;

FIG. 4 is a diagram of another exemplary system for determining orientation of a workpiece in accordance with the present disclosure;

FIG. 5 illustrates a comparison of silicon-on-glass and glass-on-silicon using a technique disclosed herein;

FIGS. 6A-6D are exemplary bare silicon results using a technique disclosed herein;

FIGS. 7A-7D are exemplary SiC results using a technique disclosed herein;

FIGS. 8A-8D are exemplary patterned wafer results using a technique disclosed herein;

FIGS. 9A-9B illustrate that bottom and top orientation of a workpiece can be distinguished by their characteristic relative reflection intensities;

FIG. 10 is a flowchart of a method in accordance with the present disclosure; and

FIG. 11 is a block diagram of an exemplary vacuum system utilizing an ion source with a target in accordance with the present disclosure.

### DETAILED DESCRIPTION OF THE DISCLOSURE

Although claimed subject matter will be described in terms of certain embodiments, other embodiments, including embodiments that do not provide all of the benefits and features set forth herein, are also within the scope of this disclosure. Various structural, logical, process step, and electronic changes may be made without departing from the scope of the disclosure. Accordingly, the scope of the disclosure is defined only by reference to the appended claims.

A stage, such as an electrostatic chuck, can for example be used to hold a workpiece in a path of an ion beam generated by an ion implanter. It may be important that a workpiece, such as a silicon-on-glass (SOG) wafer, is positioned on the stage with the correct orientation. The workpiece may be transferred multiple times between a load lock and the stage if multiple implants are performed on a workpiece, which can introduce orientation errors on the stage. Implants are designed for the silicon side of the SOG wafer rather than the glass side of the SOG wafer. Thus, which surface of the SOG wafer is exposed to the ion beam should be checked prior to implantation. Similar effects can occur if the workpiece is incorrectly oriented during deposition, etching, or other processes.

Without visual inspection of workpiece orientation and type of workpiece, mistakes may cause irreversible process errors. Manual inspection of the workpiece is challenging given the throughput concerns of the semiconductor industry and the desire to minimize operators in a semiconductor fabrication facility. In an instance, thin SOG wafers need additional inspection because it is difficult to know correct orientation just by visual inspection. Current ion implanters or other semiconductor processing equipment lack a workpiece orientation and workpiece type detection device. It has been recognized and appreciated herein that a laser-based (i.e., light wave) detection system using reflection measurements and transmission properties of workpiece materials can determine orientation and/or material of the surface impinged by the light. This technique can be automated and avoids the problems associated with visual confirmation. This technique also avoids adding complex sensors in an environment that can have extreme temperatures, vacuum conditions, and/or exacting cleanliness requirements.

Ideally, workpieces should be in the upright orientation (e.g., front up, device side up, or silicon up) position during processing, such as during ion implantation. The workpiece also should be upright when transferring from a load port to an aligner, an aligner to a load lock chamber, or a load lock chamber to a process chamber. Generally, contact with the front side of the workpiece is avoided to minimize any contamination, scratches, or particulate generation. A Front Opening Unified Pod (FOUP) or other workpiece-containing box is assumed to be loaded with correct orientation and type of workpiece. However, without visual inspection of workpiece orientation, an orientation error can cause irreversible process loss. Particularly, SOG wafers may need more scrutiny because visual inspection may mistake the orientation. Embodiments disclosed herein include a laser based (light wave) detection system that uses the reflection and transmission properties of relevant workpiece materials and their construction to determine orientation and materials. Benchtop experimental data shows that this technique can be used in an ion implanter or in other semiconductor processing equipment.

SOG wafers are thin wafers that include a silicon layer deposited on a glass layer, which can be a glass substrate. SOG wafers are commonly used in the fabrication of microelectronic devices, such as sensors and displays, because of their combination of electrical, thermal, and optical properties. The glass layer provides mechanical stability and allows for easy handling. The silicon layer provides electrical conductivity and the ability to process and integrate active electronic components. The thickness of the silicon layer can be configured to meet specific application requirements. The fabrication process for SOG wafers involves depositing the silicon layer onto the glass layer using various techniques, such as chemical vapor deposition (CVD) or plasma-enhanced CVD (PECVD). SOG wafers have several advantages, including a low cost, high thermal conductivity, and easy handling.

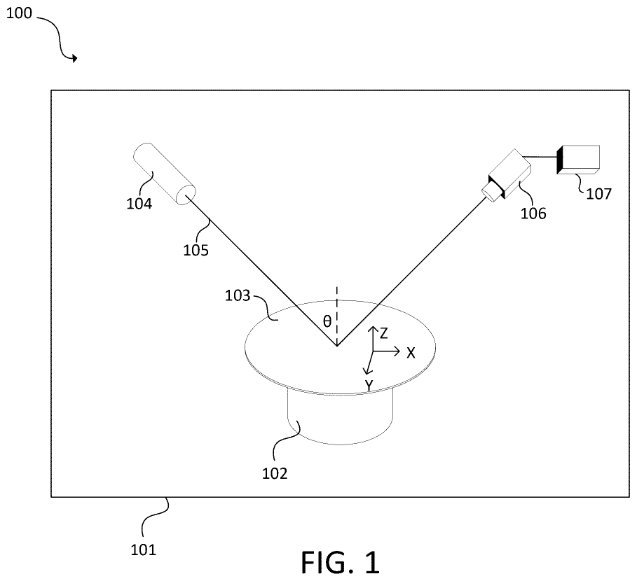

FIG. 1 is a diagram of a system 100 for determining the orientation and/or type of material of a workpiece 103 in accordance with some embodiments. The workpiece 103 may be a SOG wafer or other types of workpieces. Orientation can include which of the flat surfaces of the workpiece 103 is facing upward from a stage 102 (e.g., whether the workpiece 103 is upside-down on the stage 102). The type of material of the workpiece 103 that is measured can be the surface facing upward from the stage 102 or other workpiece handling equipment. The system 100 includes a chamber 101. The chamber 101 may be, for example, an end station, such as the one included in an ion implantation system as will be described in further detail hereinafter. The chamber 101 also can be a process chamber or another chamber that includes a stage 102 to support a workpiece 103. The chamber 101 may operate at reduced pressure, vacuum, atmospheric pressure, or a pressure above atmospheric pressure. For implantation applications, the chamber 101 operates at vacuum.

As illustrated in FIG. 1, the stage 102 is positioned in the chamber 101. The stage 102 can be, for example, an electrostatic chuck. Alternatively, the stage 102 may be a chuck that physically clamps the workpiece 103 (i.e., a mechanical chuck), a vacuum chuck, or a stage 102 that the workpiece 103 rests upon using gravity. The stage 102 can move in the X, Y, and/or Z axes.

A light source 104 directs an incident beam 105 at a surface of the workpiece 103 on the stage 102. The incident light 105 is directed at the surface of the workpiece 103 at an incident angle (θ) with respect to the Z-axis (which in FIG. 1 is normal to the surface of the workpiece 103), from >0° and <90°, including all angles and ranges therebetween. In an instance, the incident angle is greater than 42° for glass. With glass, an incident angle of less than 42° may result in the light passing through the glass with little or no reflectance. This critical angle can change between different materials. In an instance, the incident beam 105 has a diameter from about 0.5 mm to 0.7 mm. The diameter of the incident beam 105 can be larger than 0.7 mm, such as 10 mm. The diameter of the incident beam 105 also can be smaller than 0.5 mm. Smaller spot sizes can be used with unpatterned wafers, but the spot size may need to be large enough to capture features on a patterned wafer. The spot size may be selected to cover features on a patterned wafer.

In an instance, the light source 104 is a laser that generates predominantly red light. Red light may have improved penetration depth in the workpiece 103. In another instance, the light source 104 can be a laser that generates light within or across the visible wavelengths. In yet another instance, the light source 104 can be a laser that generates a wavelength outside the visible spectrum or wavelengths both inside and outside the visible spectrum. In addition to or in lieu of red light, near-infrared, violet, or infrared light also can be used.

As further depicted in FIG. 1, a detector 106 is configured to measure the incident beam 105 that is reflected off the workpiece 103 and is selected to detect wavelengths corresponding to those used by the light source 104. In an instance, pixel brightness is measured using the detector 106. A speckle pattern can be measured as part of the pixel brightness. The detector 106 may, in an embodiment, be physically located inside the chamber 101 (as schematically depicted in FIG. 1) or, alternatively, may be located outside the chamber 101 (e.g., located to be able to image the incident light 105 that is reflected off the workpiece 103 through a window (not shown) in the chamber 101). In an instance, the detector 106 is a camera or photodiode.

A processor 107 is in electronic communication with the detector 106. The processor 107 can be configured to determine an orientation or type of material for the workpiece 103 on the stage 102 based on the measured incident beam 105 reflected from the workpiece 103. The processor 107 may include a programmable processor, which is programmed in software and/or firmware to carry out the functions that are described herein, along with suitable digital and/or analog interfaces for connection to the other elements of system 100. Alternatively or additionally, the processor 107 comprises hard-wired and/or programmable hardware logic circuits, which carry out at least some of the functions of the processor 107. Although the processor 107 is shown in FIG. 1, for the sake of simplicity, as a single, monolithic functional block, in practice the processor 107 may comprise multiple, interconnected control units, with suitable interfaces for receiving and outputting the signals that are illustrated in the figures and are described in the text. Program code or instructions for the processor 107 to implement various methods and functions disclosed herein may be stored in readable storage media, such as a memory in the processor 107 or other memory.

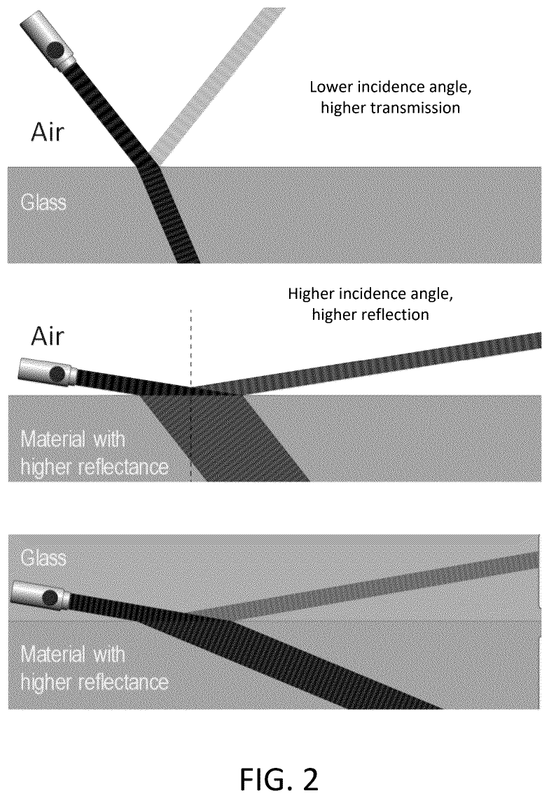

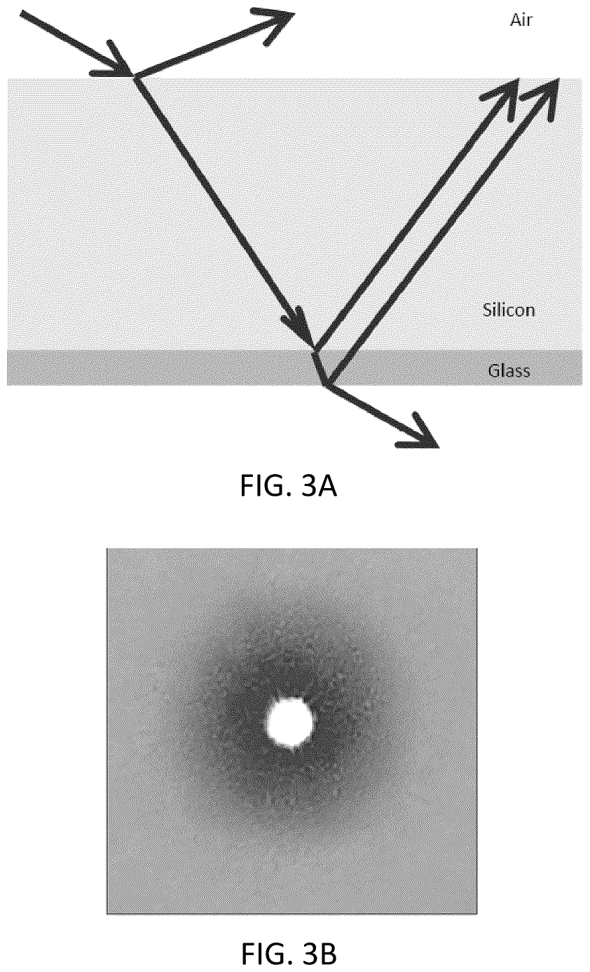

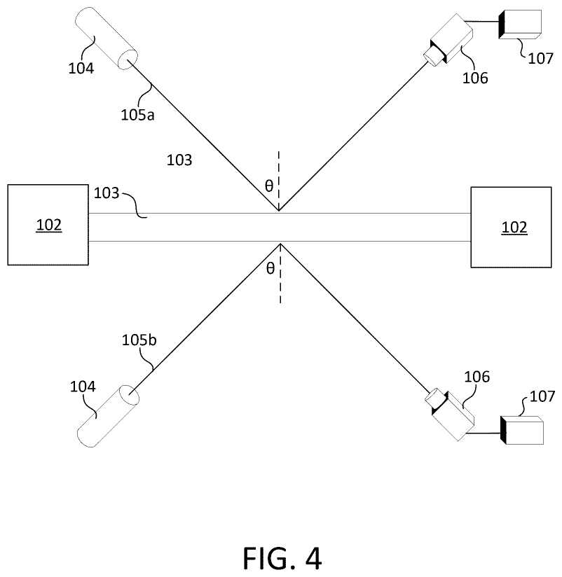

FIGS. 2, 3A, and 3B explain an embodiment of the operation. Fresnel equations describe the reflection and transmission of light when incident on an interface between different optical media. Fresnel equations can be used to predict the differing behavior of waves of the s and p polarizations incident upon a material interface. The general reflection and transmission are dependent on the material properties as well as on the incident angle. In general, any light projected with an incident angle more than the characteristic critical angle (e.g., 42° for glass) from one media to another will bend the light wave (i.e., slow down the light wave). Some of the light will reflect back and some of the light will transmit through. If the media is not a crystal and has larger thickness, some of the light will disperse and reflect back as speckle pattern like that shown in FIG. 3. FIG. 3A shows various light paths that are possible when different interfaces are present between air, silicon, and glass. As shown in FIG. 3A, both reflectance and refraction are possible. FIG. 3B shows an exemplary measured incident beam for a SOG wafer, which can collect light like that depicted in FIG. 3A.

A speckle pattern can carry information about the material of the workpiece 103. Speckle patterns are based on the surface of the workpiece 103 and can be formed by x-ray diffraction or other techniques. Roughness, porosity, strain, and stress can influence the distribution, size, or shape of the speckle pattern. The distribution, size, or shape can vary between workpieces 103 or even different parts of the same workpiece 103. The detector 106 can image the workpiece 103 to provide the speckle pattern. A speckle pattern relates to surface finish and strain. A bottom of a workpiece may have different surface finish than the top, which will affect speckles differently. There may be fewer speckles on a bottom surface of a workpiece because there is less distortion.

FIG. 2 shows a benchtop test using an incident angle of 80° to confirm that all material in the workpiece contributes to both reflection and transmission so that the loss of light can be distinguished and also to ensure a larger distribution of speckle pattern, if generated. Three examples are illustrated using different materials. The table below shows example Fresnel calculations for S-polarized light for glass and single crystal silicon for various incident angles.

| Incident | Transmission | Reflection | Transmission | Reflection |
|---|---|---|---|---|
| Angle | Glass | Glass | Silicon | Silicon |
| 0° | 96% | 4% | 59.2% | 40.8% |
| 45° | 90.8% | 9.2% | 52% | 48% |
| 60° | 82.3% | 17.7% | 40.6% | 59.4% |
| 80° | 46.1% | 53.9% | 16.6% | 83.4% |

The reflection and transmission characteristics of materials, such as glass and silicon, can be used to analyze the workpiece. As shown in FIG. 2, the reflection intensity from a top of the workpiece is a characteristic of the workpiece type and orientation for a fixed focus area, power, and incidence angle. As also as shown in FIG. 2, the ratio of the reflection intensities for top and bottom of the workpiece is a characteristic of the workpiece type and orientation for the same fixed focus area, power, and incidence angle.

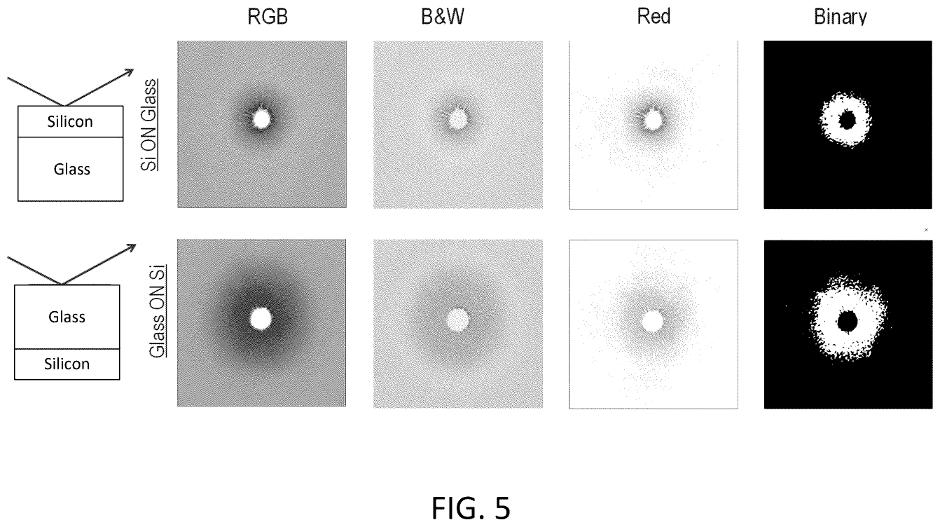

An experiment used a helium-neon 633 nm (red) laser at 4 milliwatts (mW). The laser had a beam diameter of approximately 0.50 to 0.7 mm. An incident angle of 80° was used. As the critical incident angle for glass is approximately 42° for reflection, any incident angle from 50° to 89° can be used for the reflection measurement experiment. The detector was an iPhone camera. Images were analyzed using ImageJ, which can restrict the image to a particular wavelength (e.g., red wavelength). In an instance, only the top of the workpiece was measured, as shown in FIG. 1. In another instance, opposite surfaces (i.e., top and bottom) of the workpiece 103 were measured, as shown in FIG. 4. In FIG. 4, a stage 102 holds only the edges of the workpiece 103 so that both the top and bottom of the workpiece 103 can be measured. Incident beam 105a images the top surface of the workpiece 103 and incident beam 105b images the bottom surface of the workpiece 103. A workpiece 103 may not have a standard value that can be used for comparison, so imaging the bottom of the workpiece 103 can provide a reference to use when evaluating the top of the workpiece 103. Analyzing both the top and bottom of the workpiece 103 also can enable a review of variation. While two processors 107 are illustrated in FIG. 4, a single processor 107 may be used.

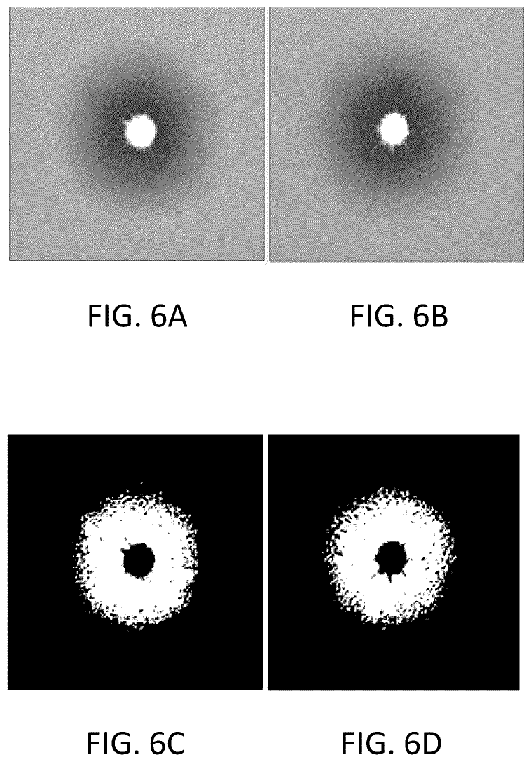

For silicon on glass, reflection image analysis shows higher integrated density for RGB, black and white, and red, but binary image analysis shows lower integrated density indicating smaller speckle pattern distribution. For glass on silicon, reflection image analysis shows lower integrated density for RGB, black and white, and red, but binary image analysis shows higher integrated density indicating larger speckle pattern distribution. These results are shown in FIG. 5.

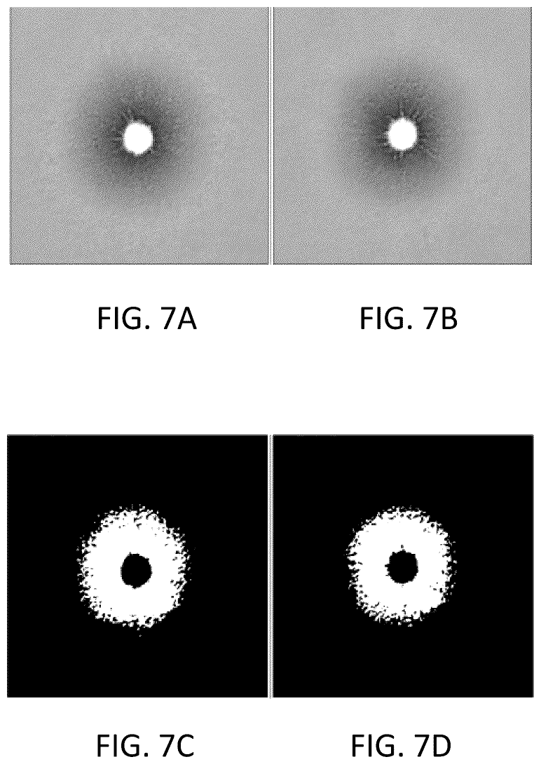

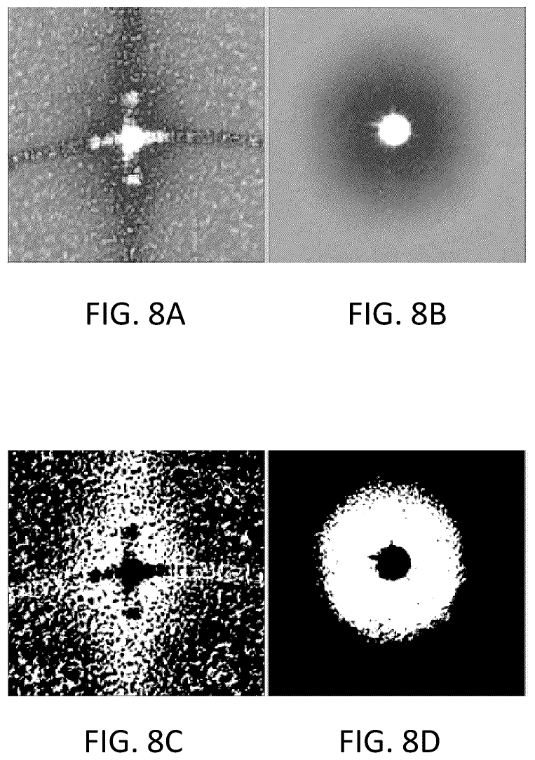

For a bare silicon workpiece and a SiC wafer, reflection image analysis shows slightly higher integrated density for both RGB and binary images for the top surface compared to the bottom surface. This slightly higher reflection density for the top surface may be related to better surface finish. Bare silicon results are shown in FIG. 6A-6D. SiC workpiece results are shown in FIG. 7A-7D. The top images (FIGS. 6A-6B, FIGS. 7A-7B) show the red wavelength and the bottom images (FIGS. 6C-6D, FIGS. 7C-7D) show the resulting binary image. Two examples are shown on the left and right of FIGS. 6A-6D and FIGS. 7A-7D.

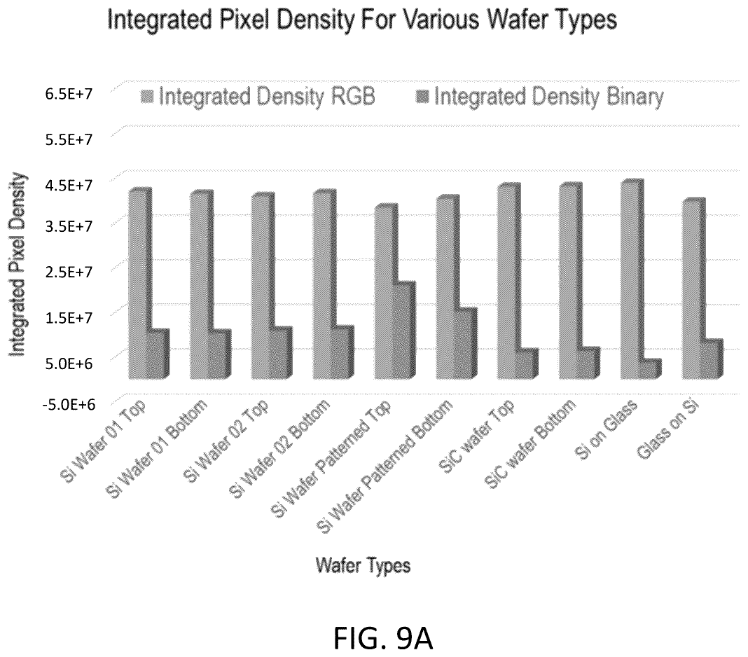

For a patterned silicon workpiece, reflection image analysis shows lower integrated density for RGB, but higher integrated density for a binary image for the top surface compared to that of the bottom surface. In general, a patterned workpiece reflects more due to embedded shiny metal features buried underneath. The reflection measurement shows that both top and bottom orientation of the patterned workpiece are visibly higher compared to that of bare silicon, SiC, and SOG wafers. However, reflectance from the top is higher compared to that of bottom of the patterned wafer due to the lower depth of the buried metal feature. These results are shown in FIG. 8A-8D. It is expected that any patterned wafer for any of the mentioned types (SiC, SOG, etc.) will behave similarly. The left images (FIGS. 8A and 8C) show a patterned wafer and the right images (FIGS. 8B and 8D) show an unpatterned wafer. The top images (FIGS. 8A-8B) show the red wavelength and the bottom images (FIGS. 8C-8D) show the resulting binary image.

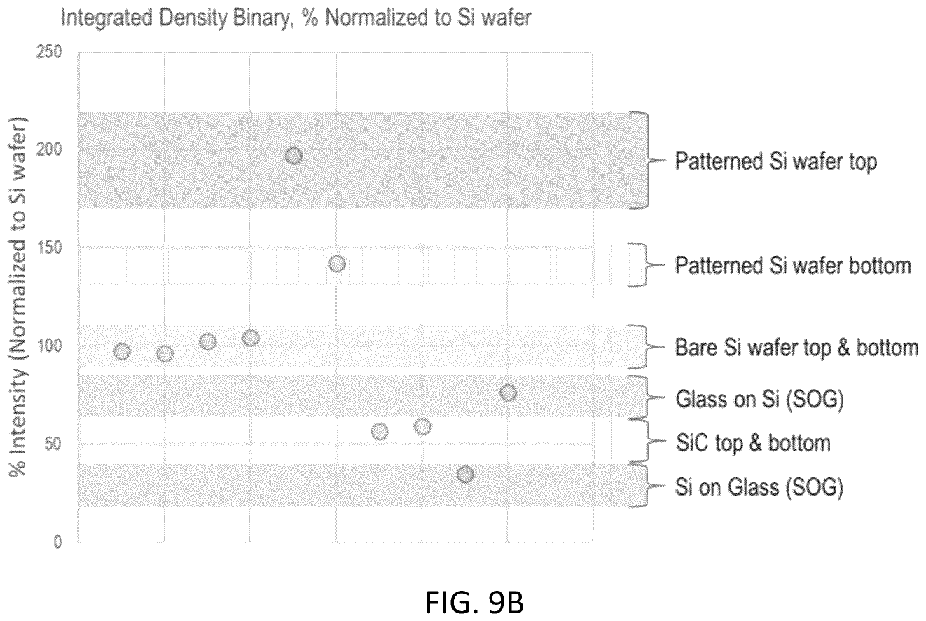

Reflection intensity determined from binary pixels shows more sensitivity compared to RGB pixels. The binary pixels tend to be more pronounced because they are black and white. Each wafer type can be predicted within a narrow band of reflection intensity. Also, the bottom and top orientation of a workpiece can be distinguished by their characteristic relative reflection intensities. This is shown in FIGS. 9A-9B. Each material may have a standard that can be used for comparison with measurements. The chart in FIG. 9A shows integrated reflection density from RGB (left bar for each wafer type) and binary images (right bar for each wafer type) for different types of workpieces. Reflection intensity determined from binary pixels shows more sensitivity compared to RGB pixels. The chart in FIG. 9B demonstrates that each workpiece type can be predicted within a narrow band of reflection intensity. Thus, the intensity for a particular angle and type of incident light can be used to determine the material of the surface reflecting the incident light. Knowing the material can be used to determine the orientation of a workpiece. For example, for SOG wafers and patterned silicon wafers, the bottom and top orientation can be distinguished by relative reflection intensities. The same may be true for other types of workpieces. Each material on a workpiece has different optical properties, which can lead to different intensities.

Based on the experiment, a binary image can be related to a speckle pattern distribution, which can be easier to use for analysis than RGB, black and white, or red images. Integrated reflection intensity from a binary image can be used to detect the type of workpiece. Each workpiece type that can be evaluated using techniques disclosed herein has a characteristic bandwidth of reflectance that does not overlap with other types of workpiece (e.g., SiC wafer, SOG wafer, GaN wafer, unpatterned or bare silicon wafer, or patterned silicon wafer). If the ratio of the top and bottom RGB reflection intensities for a workpiece is less than one, then the workpiece may be upside-down. A patterned silicon wafer can be distinguished from a non-patterned wafer due to its higher reflectance. A patterned silicon wafer top face orientation can be distinguished from the bottom face due to higher reflection. Glass-on-silicon reflects more than the silicon-on-glass, which can be used to determine orientation. The top and bottom of a polished bare silicon wafer reflect slightly differently, but distinguishing the orientation may not be possible without additional information.

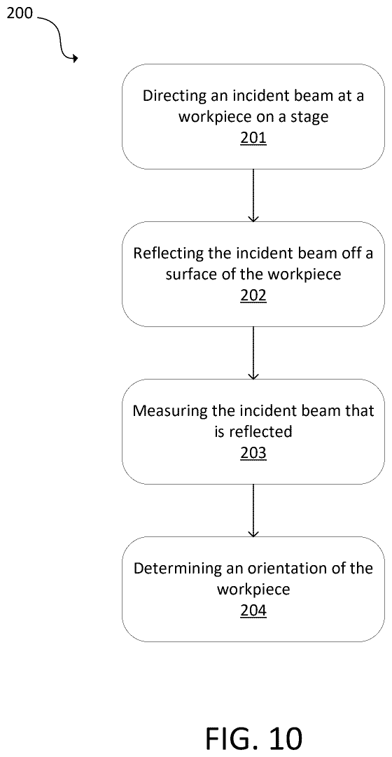

FIG. 10 is a flowchart of a method 200. The method 200 can be performed in any of the embodiments of the system disclosed herein, such as system 100. At block 201, an incident beam 105 is directed from a light source 104 at a workpiece 103 on a stage 102 in a chamber 101. The incident beam 105 is directed at the surface of the workpiece 103 an incident angle, θ, with respect to a normal axis to the surface. This may be, for example, an overall flat surface of the workpiece with an opposite flat surface. In an instance, the surface may be considered as a plane from the circumference or edge of a workpiece. The incident beam 105 can be a red laser beam or a laser beam of another wavelength or wavelengths. In an instance, the θ is an angle from >0° and <90°.

At block 202, the incident beam 105 is reflected off a surface of the workpiece 103. The incident beam that is reflected off the workpiece is measured at block 203. Using a processor 107, an orientation of the workpiece 103 is determined based on the reflected incident beam at block 204. This may use a binary image of the reflected incident beam. A workpiece 103 may be scrapped based on the orientation. The functionality of the workpiece handling system can be checked using the orientation. A system interlock also can be used to prevent operation if the orientation is incorrect. A workpiece 103 can be sent back to an aligner for repositioning depending on the orientation. The aligner can reposition the workpiece 103 to have the desired orientation. One or more robots can adjust placement of the workpiece 103 on the stage 102 as the workpiece 103 is moved to or from the stage 102.

In another embodiment, a non-transitory computer-readable storage medium includes one or more programs for executing steps on one or more computing devices. Measurements of an incident beam of light reflected off a surface of a workpiece on a stage is received. The incident beam is directed at the surface of the workpiece at an oblique angle. An orientation of the workpiece on the stage is then determined based on the measurements. Other determinations, such as analyzing the material of the workpiece, also can be performed.

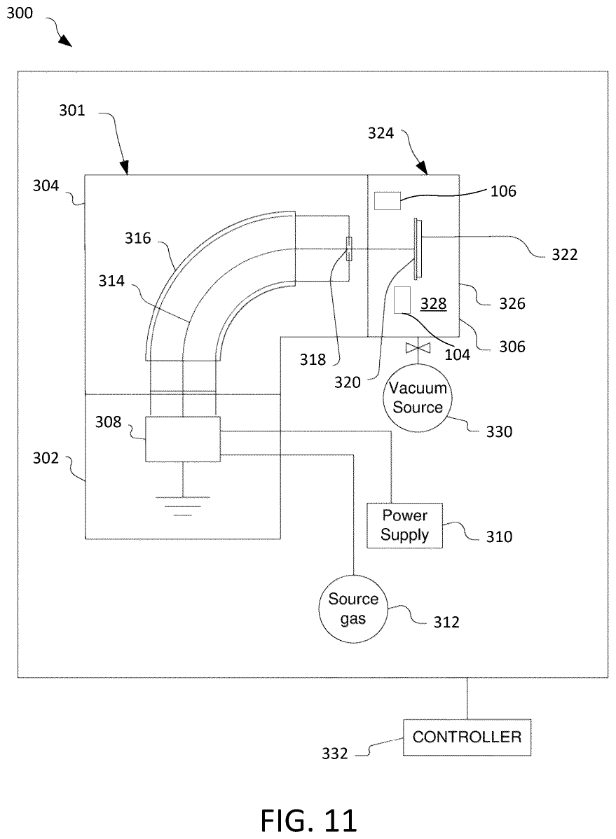

FIG. 11 illustrates an exemplified vacuum system 300 that may implement various apparatus, systems, and methods of the present disclosure. The vacuum system 300 includes an ion implantation system 301, however various other types of vacuum systems are also contemplated, such as plasma processing systems or other semiconductor processing systems. The ion implantation system 301, for example, comprises a terminal 302, a beamline assembly 304, and an end station 306.

Generally speaking, an ion source 308 in the terminal 302 is coupled to a power supply 310, whereby a gas from a gas source 312 (also called a dopant gas) supplied thereto or material from a target is ionized into a plurality of ions to form an ion beam 314. The ion beam 314 is directed through a beam-steering apparatus 316 and out an aperture 318 toward the end station 306. In the end station 306, the ion beam 314 bombards a workpiece 320 (e.g., a semiconductor such as a silicon wafer, SiC wafer, a display panel, SOG wafer, GaN wafer, etc.), which is selectively clamped or mounted to a stage 322 (e.g., an electrostatic chuck). Once embedded into the lattice of the workpiece 320, the implanted ions change the physical and/or chemical properties of the workpiece 320. Because of this, ion implantation is used in semiconductor device fabrication and in metal finishing, as well as various applications in materials science research.

The ion beam 314 of the present disclosure can take any form, such as a pencil or spot beam, a ribbon beam, a scanned beam, or any other form in which ions are directed toward end station 306, and all such forms are contemplated as falling within the scope of the disclosure.

The end station 306 includes a process chamber 324, such as a vacuum chamber 326, wherein a process environment 328 is associated with the process chamber. The process environment 328 within the process chamber 324, for example, comprises a vacuum produced by a vacuum source 330 (e.g., a vacuum pump) coupled to the process chamber 324 and configured to substantially evacuate the process chamber 324. A controller 332 is provided for overall control of the vacuum system 300. The controller 332 can include the processor 107 or may be separate from the processor 107.

The ion source 308 (also called an ion source chamber), for example, can be constructed using refractory metals (W, Mo, Ta, etc.) and graphite in order to provide suitable high temperature performance, whereby such materials are generally accepted by semiconductor manufacturers. The gas from the gas source 312 is used within the ion source 308. The source gas may or may not be conductive in nature.

The vacuum system 300 can use any of the embodiments disclosed herein. Thus, the end station 306 can include the components of the system 100 disclosed herein, such as the light source 104 or the detector 106. The end station 306 may be an example of a chamber 101 and the stage 322 may be an example of a stage 110. The workpiece 320 can be an example of the workpiece 103.

The embodiments of the present disclosure also may be implemented in various semiconductor processing equipment such as that for CVD, PECVD, physical vapor deposition (PVD), metal organic chemical vapor deposition (MOCVD), chemical-mechanical polishing (CMP), etching, and various other semiconductor processing applications, and all such implementations are contemplated as falling within the scope of the present disclosure.

Although the present disclosure has been described with respect to one or more particular embodiments, it will be understood that other embodiments of the present disclosure May be made without departing from the scope of the present disclosure. Hence, the present disclosure is deemed limited only by the appended claims and the reasonable interpretation thereof.

What is claimed is:

1. A system comprising:
a chamber;
a stage configured to hold a workpiece, wherein the stage is disposed within the chamber;
a light source configured to direct an incident beam at a surface of the workpiece on the stage, wherein the incident beam is directed at the surface of the workpiece at an incident angle, θ, with respect to a normal axis to the surface;
a detector configured to measure intensity of the incident beam reflected off the workpiece; and
a processor in electronic communication with the detector, wherein the processor is configured to determine an orientation of the workpiece relative to the stage using measurements of the intensity.

2. The system of claim 1, wherein the light source is a laser and the incident beam is predominantly red light.

3. The system of claim 1, wherein the incident beam has a diameter from 0.5 mm to 0.7 mm.

4. The system of claim 1, wherein θ is from >0° and <90°.

5. The system of claim 1, wherein the detector is a camera.

6. The system of claim 1, wherein the stage is an electrostatic chuck.

7. The system of claim 1, wherein the workpiece is a silicon-on-glass wafer.

8. The system of claim 1, further comprising a second light source and a second detector, wherein the second light source and the second detector are configured to measure intensity of a second incident beam reflected off an opposite surface of the workpiece.

9. The system of claim 1, wherein the processor is further configured to determine a type of material on the surface of the workpiece that reflects the incident beam.

10. A method comprising:
directing an incident beam from a light source at a workpiece on a stage in a chamber, wherein the incident beam is directed at a surface of the workpiece at an incident angle, θ, with respect to a normal axis to the surface;
reflecting the incident beam off the surface of the workpiece;
measuring intensity of the incident beam that is reflected off the workpiece; and
determining, using a processor, an orientation of the workpiece relative to the stage using measurements of the intensity.

11. The method of claim 10, wherein the light source is a laser and the incident beam is predominantly red light.

12. The method of claim 10, wherein 0 is from greater than >0° and <90°.

13. The method of claim 10, wherein the workpiece is a silicon-on-glass wafer.

14. The method of claim 10, further comprising measuring intensity of a second incident beam that is reflected off an opposite surface of the workpiece.

15. The method of claim 14, further comprising comparing the measurements of the intensity of the incident beam and the measurements of the intensity of the second incident beam when determining the orientation.

16. The method of claim 10, further comprising determining a type of material on the surface of the workpiece that reflects the incident beam.

17. A non-transitory computer-readable storage medium, comprising one or more programs for executing the following steps on one or more computing devices:
receiving measurements of intensity of an incident beam of light reflected off a surface of a workpiece on a stage, wherein the incident beam is directed at a surface of the workpiece at an incident angle, θ, with respect to a normal axis to the surface; and
determining an orientation of the workpiece relative to the stage using measurements of the intensity.

18. The non-transitory computer-readable storage medium of claim 17, wherein the workpiece is a silicon-on-glass wafer.

19. The non-transitory computer-readable storage medium of claim 17, wherein the determining uses measurements of an intensity of a second incident beam of light of an opposite surface of the workpiece.

20. The non-transitory computer-readable storage medium of claim 17, wherein the steps further include determining a type of material on the surface of the workpiece that reflects the incident beam.
